(19) United States
(12) Patent Application Publication
(10) Pub. No.: US 2010/0154163 A1
(43) Pub. Date: Jun. 24, 2010

(54) DOOR ARRESTER

(76) Inventor: Peter Hoffmann, Overath (DE)

Correspondence Address: Davidson, Davidson & Kappel, LLC, 485 7th Avenue, 14th Floor, New York, NY, 10018, US

(21) Appl. No.: 12/449,318

(22) PCT Filed: Feb. 1, 2008
(86) PCT No.: PCT/DE2008/000185

§ 371 Date: Jan. 7, 2010

(30) Foreign Application Priority Data
Feb. 1, 2007 (DE) 10 2007 005 947.9
May 16, 2007 (DE) 10 2007 023 110.7

(51) Int. Cl. E05F 5/08; E05F 5/02

(52) U.S. Cl. 16/85; 16/82

(57) ABSTRACT

The invention relates to a door holder, comprising a housing (12) that can be fastened to one door and door frame, a stay bar (11), which penetrates an opening (14) in the housing (12) and can be pivotally fastened to the other door and door frame, and at least one braking member (15), which interacts with a flat side (20) of the stay bar (11) and is disposed in the housing (12), wherein the flat side (20) and the braking element (15) are biased toward each other at least in regions of the extension of the stay bar (11), wherein a retaining force can be produced, which acts at least in one of the displacement directions of the stay bar (11) as a function of the local surface property of the flat side (20) and of the braking member (15). A door holder enabling reliable and safe locking, which may also be produced in a cost-effective manner, can be created according to the invention in that at least either the force application or the local surface property is modified along the extension of the stay bar (11), and that the resulting retaining force thus varies across the extension of the stay bar (11).

The invention relates to a door arrester according to the preamble of claim 1, comprising a housing which can be fastened to one of a door and a door frame, a holding rod which extends through an opening in the housing and which can be pivotably fastened to the other of the door and the door frame, and at least one brake member which interacts with a flat side of the holding rod and which is arranged in the housing, wherein the flat side and the brake member are preloaded against one another at least in regions of the extent of the holding rod, wherein a holding force acting at least in one of the movement directions of the holding rod can be generated depending upon the local surface properties of the flat side and of the brake member.

DE 100 25 185 A1 or WO 01 90 518 A1 shows a door arrester in which a holding rod is arranged in a movable fashion in an opening of a housing. Provided in the housing are two latching members which are axially movable in the housing and which are preloaded in the direction of the flat side of the holding rod by means of a pressure spring. The brake members are embodied as hollow cylinders, wherein the pressure springs being arranged partially within the latching members. The housing has a cavity in which the latching members are arranged, wherein a diameter of the latching members being adapted to the cavity. A disadvantage of said type of door arresters is that the engagement calottes of the latching members are of spherical design, such that the latching marks arranged on the holding rod must be designed to be relatively large, and therefore only a limited number of latching positions are possible and the holding force is limited outside the latching marks.

FR 2 666 616 A1 presents a door arrester for a motor vehicle, which door arrester comprises a housing, wherein the housing features a first housing half and a second housing half. The two housing halves define an opening, wherein the first housing half and the second housing half in each case delimit only a section of the circumference of the opening. A holding rod which is pivotably arranged on a door arrangement part extends through the opening, wherein the holding rod is formed from two metallic, elastic blades which are connected to one other at their outer ends and which, in a central region, form a cavity for the holding rod. Formed in each of the two housing halves are two cylindrical recesses in which two guide rollers are mounted so as to be exclusively rotatable, wherein the guide rollers are arranged in the cavity of the holding rod, and one of the guide rollers respectively being in contact with one flat side of one of the two blades. Two further, exclusively rotatable guide rollers are provided in the housing and are aligned perpendicularly with respect to the guide rollers and are in contact with thin, outer flat sides of the two blades. The two blades have a wave-shaped profile which is symmetrical with respect to an axis of extent, wherein the axis simultaneously is the axis of symmetry of the housing. The two guide rollers can be secured in the wave troughs and define preferred latching positions of the arrester. A disadvantage of this type of door arrester is the fact that the holding rod comprises two blades which form a cavity, thus resulting in easy deformation of the holding rod due to frequent use of the door, for example. In the event of deformation of one of the two blades, or else of both, the wave profile is deformed asymmetrically and the defined latching positions are displaced or disappear, such that an arresting of the door is no longer certain or even no longer possible. A further disadvantage is that the guide rollers function toward arresting and also toward guiding the holding rods. A holding force which is sufficient to provide stable arresting of the door cannot be obtained with the rolling friction generated by the rollers only.

U.S. Pat. No. 5,173,991 A shows a door arrester which comprises a housing and a cover which covers the housing. The housing and the cover respectively have one opening, which openings are aligned with respect to each other. The housing and the cover are fastened to the door or the door frame by means of two screws. A holding rod which has an upper and a lower flat side, wherein each of the two flat sides have a groove in the direction of extent of the holding rod, extends through the two openings. Recesses in which a brake member respectively can be secured are provided in the two grooves. Each of the two brake members comprises a ball, which is in contact with the groove of the holding rod, and a plastic element, which is preloaded in the direction of the holding rod by a spring element and in which the ball is mounted on the side facing away from the spring element. During an opening or closing movement of the door, the holding rod is guided by the housing and the balls of the two brake members are carried along in the groove, with the recesses of the groove constituting latching positions for the movement of the door.

In door arresters known from practice, of the type in which the flat side of a to holding rod is acted on by a brake member which is arranged in a housing having an opening through which the holding rod extends, it is the case even when the brake members are embodied as balls or as sliders or as latching members formed with latching lugs that the pairing of the brake member and the surface of the flat side generates a friction coefficient, wherein in the prior is art, said friction coefficient is selected to be as low as possible, so as to effect the arresting of a vehicle door generally by means of latching marks. Said latching marks are of elevated or recessed design in such a way that, even with the generally weak characteristic of the spring, said latching marks lead to a perceptible resistance to be overcome and to a corresponding holding force of the door during the movement of the holding rod therewith. Herein it is crucial that, the spring deflection is varied substantially as a result of the design of the holding rod, and for example the holding force of the brake member on the surface of the holding rod is not altered.

It is the object of the invention to create a door arrester according to the preamble of claim 1 which enables reliable and secure arresting and which can be produced in a cost-effective manner.

According to the invention, said object is achieved with the door arrester specified in the introduction by means of the characterizing features of claim 1.

The door arrester according to the invention, which is expediently a door arrester for a motor vehicle door, provides stepless arresting of a vehicle door, even without precisely defined latching positions, but nevertheless with preferred latching regions, with the holding force being sufficient to prevent an inadvertent pivoting of the vehicle door. Herein, at least one of loading and local surface properties of the holding rod varies over the progression of the holding rod in order to correspondingly adjust the resultant local holding torque. The surface properties encompass for example the friction coefficient or the roughness of the holding rod, and also further microstructural properties and material properties.

It is possible for the resultant holding force to increase linearly over the extent of the holding rod, for example during the opening of the door, and for example to decrease during the closing of the door, as a result of which a continuous increase in the holding force in the direction of the maximum opening angle signals that the maximum possible opening position is reached. It is preferable, however, for the loading and the local properties to be selected so as to generate a plurality of regions of approximately equal holding force, so as to provide for the user a comfortable holding force profile, which rises in a stepped fashion, during the opening of the door. It is also possible for more complex profiles of holding force to be obtained by means of a corresponding combination of holding rod and brake member.

It is possible for only one parameter out of loading and local properties to be varied along the extent of the holding rod respectively, but it is expediently also possible for both parameters to be set, as a function of the opening angle of the holding rod and/or of the distance travelled by the holding rod in the housing, in such a way that the resulting holding forces may also assume a discontinuous profile over the extent of the holding rod.

The flat side of the holding rod facing toward the brake member is expediently substantially planar, that is to say provision is made for neither elevations nor depressions which define preferred opening angles of the door as a result of latching of the brake member into corresponding fixed positions. The latching positions which are required in conventional designs in order to be able to hold a door open even against the action of wind or in the case of inclined vehicles are obtained preferably without latching and at any desired opening angles. For a user, this provides the advantage that the vehicle door is arrested in an open position even at an angle which is adjacent to a latching position and which, in the case of a latching arrangement, would always only be a unstable holding position with a tendency to move into the stable latching position. This consequently permits stepless arresting of a holding rod, wherein the holding force for adjusting the door out of a fastened position is the same respectively, at least in identical holding sections. It is understood from that stated above that the flat side may also have a slight curvature or lateral or longitudinal slope which nevertheless enables said flat side to make contact preferably over its full area with the corresponding brake member.

According to a first preferred refinement of the invention, the flat side of the is holding rod has a plurality of sections with different coefficients of friction μ. In this way, sections of different holding forces are advantageously created, said holding forces being adjustable by the selection of the friction coefficient of the corresponding section.

In a first preferred method for producing a holding rod of said type, the sections of different coefficient of friction μ are produced independently of one another and connected to one another in a connecting step, such that the holding rod is then composed of different segments. The surface of the holding rod herein is preferably substantially planar, and at least has no depressions which generate latching of the brake member. The connection may be achieved in various ways, preferably by means of adhesive bonding, joining, welding, friction stir welding, stapling or the like, or else by means of positive interlocking of the corresponding parts and subsequent encasement in the region of the particular surface which does not interlock with the brake member.

According to another preferred method for producing a holding rod having a plurality of sections with different coefficients of friction μ, the holding rod is initially produced in one piece, for example by means of sintering or coating of a metal part, or is subsequently surface-processed in different ways section by section, such that the roughnesses of the resulting sections differs in such a way as to produce different coefficients of friction μ. For the surface processing, consideration is given in particular to known grinding and polishing processes which reduce the roughness of the corresponding surface section and therefore the coefficient of friction p; it is however also possible by means of sandblasting methods or other roughening methods to intentionally produce sections with a greater degree of roughness and therefore a greater coefficient of friction p; in particular, it is possible for said methods for increasing and for reducing the coefficient of friction μ to be used on the same holding rod. An alternative method for processing the surface is that of laser-machining of the surface, which can lead to a change in roughness in certain ceramics and metals. One advantage of said method is that the reflectivity of the differently processed surfaces differs, thereby enabling a simple visual inspection of the properties and quality without the necessity to carry out measurements of the roughness or of the coefficient of friction μ every time.

According to a further preferred method for producing a holding rod having at least one section with an increased coefficient of friction, a brake lining is fixed to at least one of the sides of the holding rod, preferably to a wide side of the holding rod. This may be achieved through adhesive bonding or riveting, but the brake lining is preferably fixed by material engagement to the holding rod, for example by being injection moulded in a plastic injection moulded part or being sintered. It is alternatively also possible for a corresponding brake lining to be fastened to the holding rod by means of clips, screws or other known connecting means, wherein it should be ensured that the connecting means as far as possible do not impair the movement of the holding rod. A brake lining of said type may for example be designed or formed in the manner of brake linings for wheel brakes of motor vehicles, and produced in particular as a powder metallurgical molded part composed of ceramic, hard metal, petroleum coke, metal chips or combinations of these, expediently with the addition of a binding agent based on resin, synthetic resin or rubber. By means of a corresponding variation of the binding agent and addition of organic substances or plastics, it is possible for the sliding properties to be improved at least so as to reduce or prevent an undesired generation of noise. To avoid the running-in behavior commonly observed with such linings when the door arrester is installed, the surface of the brake lining is expediently machined, for example trued, or ensured in some other way that the roughness generated in operation and the associated coefficient of friction μ are generated.

To prevent regions of different roughnesses arranged in series in the movement direction of the holding rod from becoming smeared, it may alternatively be provided that a plurality of tracks of friction linings, at least partially are arranged side by side in the direction of extend of the holding rod, wherein the brake lining comes into contact with the corresponding surface region respectively, with one type of friction lining only and thereby preventing substantially a dispersal. The corresponding holding force is then composed of the holding forces of the individual sections, with it being possible to intermittently omit at least one friction lining section where the latter is not required.

Regardless of the material from which it is composed, the flat side of the holding rod expediently has coefficients of friction μ of between 0.025 and 0.5, preferably between 0.04 and 0.45, and ideally different, discrete values within said range, such as for example 0.05; 0.11; 0.14; 0.18; 0.22; 0.27; 0.32; 0.36; 0.40. If a holding rod having a flat side composed of one single brake lining is selected, then the coefficient of friction μ of said brake lining is between 0.14 and 0.2.

It is possible for the holding rod to be formed with a metal core and a plastic encapsulation, with the plastic then being selected so as to provide the stated coefficients of friction μ. Since the susceptibility of plastic to wear increases with increasing roughness, it is however preferably provided that the holding rod is produced as a sintered part, with this being achieved either by producing the entire holding rod from sintered material or by sintering a coating on a metal or ceramic core. Herein it is preferably provided that the sintered material is formed with different surfaces section by section, in order to section-wise generate different aformentioned coefficients of friction μ. It is thus possible, according to one preferred method, for a core composed of metal or ceramic, for example, to be inserted into a mould in which different sections of the core are surrounded and pre-pressed with the powdered sintered material, in order to then be cohesively connected to one another by sintering. A core composed of ceramic material has the advantage that particularly good adhesion is obtained as a result of the similar material properties such as thermal conductivity and thermal expansion. If a metal core is provided, the latter is expediently formed with apertures or recesses which, in addition to the adhesive casing composed of sintered material, also permit clamping engagement and therefore positive interlocking. An advantage of providing a metal core is the fact that it is easier to form a lug for the subsequent articulated connection of the holding rod.

It is possible to provide the same sintered material for the surface of the entire holding rod, with said sintered material being provided with a varying density by means of different pre-pressing, and with it being possible in this way for said surface to be formed with different roughnesses and therefore coefficients of friction μ. Alternatively, it may also be provided that different sintered materials are selected section-wise, said different sintered materials then generating different coefficients of friction on the surface of the holding rod. Herein it is expediently sought that the different sintered materials have as far as possible only small proportions of different components in order to obtain a continuous surface without susceptibility to cracking. It is thus possible for a first section to be composed of a pure sintered material, for example Si₃N₄ (silicone nitride), for a second section to be composed of a sintered material provided with a small concentration of a first dope additive such as TiC (titanium carbide) or ZrO₂ (zircon oxide), and for a third section to be composed of the sintered material with a higher concentration of additive or with a further additive such as for example WC (tungsten carbide). In sintered materials, the doping additives generate, in part, a positive dissipation of surface stresses, as a result of which the surface quality is improved, or else the creation of vacancies in the microstructure, as a result of which the surface quality is degraded.

The sintered material is expediently selected from the group comprising carbides, nitrides, oxides, borides of metals and mixtures and/or compounds thereof. These are distinguished by a high degree of wear resistance and at the same time a high degree of process controllability during production. The sintered material preferably comprises at least one of materials tungsten carbide, silicone carbide, titanium oxide, titanium boride, silicone nitride as a base material, and also further doping substances. It is however also possible to give consideration to other classes of materials, in particular those which are known as hard metal, and also for example aluminum oxide or sialons. As metal components, consideration is given to fundamentally any metal, preferably silicone, titanium, zirconium, aluminum, tungsten, iron, vanadium.

Another preferred refinement of the holding rod is composed of grey cast iron or of steel, for example St60, which is also used for brake disks and which has a roughness which is sufficient for providing high holding forces.

An encapsulation for the holding rod is expediently provided which protects the surface of the holding rod from the deposition of liquids and other contaminants. In this way, it is expediently prevented that sand or other contaminants increase the set holding forces, or that liquid such as water or grease, even in the form of mist, reduce the set holding forces. To prevent depositions of condensate, it is expediently provided that means for absorbing moisture, such as for example silica gel, are arranged in the encapsulation. The encapsulation is expediently formed as a collapsible cover in the form of a bellows, as is used for cable leadthroughs in vehicle doors, which therefore permits virtually complete insulation of the holding rod from the environment. It is also possible to arrange plastic lips in the region of the opening of the housing, which plastic lips scrape against the surface of the holding rod as the latter passes through the housing and thereby keep said surface free from liquids or solid contaminants. Said cleaning is however expediently obtained by means of the brake member which has edges which taper to a point in the movement direction of the holding rod and which cause contaminants to be discharged to the side.

The holding rod is preferably produced from plastic material, in particular in an injection-molding process, from a polyamide, which for example contains a metal core. It is hereby possible for a brake lining to be connected to the plastic material in a simple manner. Furthermore, the selection of plastic material enables simple shaping. In particular, if only one side of the holding rod is formed as a flat side for producing a friction pair together with the brake member, a holding rod composed of plastic makes it possible for the opposite side to be designed as a guide path for a latching mechanism, in particular a preloaded latching member, with the coefficients of friction of the plastic material of the corresponding guide path and the latching member being significantly lower than that of the flat side/brake member pairing provided on the other side of the holding rod, such that the latching member can also follow latching depressions or latching marks of the guide path without problems.

The housing is expediently produced from an aluminum profile which forms an expedient material pairing in particular with ceramics. The brake member is expediently axially movable in the housing and acted on by a spring member which presses against the surface of the holding rod. In the case of a planar design of the holding rod, the brake member requires only a small working stroke. The brake member may then have a small structural height, as may the spring member which acts on the brake member. This results in a small structural height of the housing overall. Here, a housing composed of aluminum also has the advantage, even with a strong spring member, of a high level of torsional rigidity which makes it possible to impart the preload of the spring member entirely to the holding rod and therefore to use said preload to generate the holding force. It is alternatively possible to provide a plastic housing, wherein it is then necessary to take into consideration the relaxation of the plastic housing under the preload of the spring element.

The brake member expediently has a flattened front side which faces toward the flat side of the holding rod, by means of which flattened front side a large surface area comes into contact with the flat side of the holding rod and thereby generates the holding force. The size of the surface is selected as a function of the properties of the flat side of the holding rod and the desired holding force. Herein the flattened end side expediently has a circular contour which makes the brake member insusceptible to tilting or the like, and which provides the most uniform possible loading of the entire surface by the spring member. Alternatively, the front side may also have a rectangular, preferably square, shape, wherein an alignment with the corners in the movement direction of the holding rod has proven to be advantageous in order to avoid tilting in the event of sudden load shifts. The rear side of the brake member expediently has a central recess into which one end of the spring member can be inserted, as a result of which the preload of the spring member is transmitted to the entire brake member in an expedient manner. It is expediently provided, in particular in the case of a housing or brake member consisting of plastic, that a lateral surface of the brake member at least partially widens conically in the direction away from the holding rod, since the guide recess for the brake member in the plastic housing part can thus be produced by means of injection moulding in a particularly expedient manner. In contrast, in the case of a housing part composed of an aluminum profile, the guide recess is preferably of cylindrical design, such that the brake member has a substantially cylindrical lateral surface.

To preload the brake member in the direction of the flat side of the holding rod, the spring member may expediently be embodied as a helical spring or as a disk spring. An advantage of the helical spring is in particular a comparatively weak spring characteristic curve, which makes the door arrester insusceptible to wear. An advantage of the disk spring is the possibility of setting a particularly high preload for a relatively small structural height of the disk spring pack. It is however alternatively possible for the brake member to be loaded, in particular at its end opposite the front side, in any other way, for example by means of a leaf spring or by means of an elastomeric material or else by means of a hydraulic force.

The holding rod expediently has a curvature in the direction of its narrow side, the radius of which curvature corresponds to the spacing to a pivot axis of a motor vehicle door. It is alternatively possible for the opening to have a flared run-in portion which makes it possible to also perform a pivoting movement relative to the housing.

According to one preferred refinement, the holding rod, whose one end expediently has a bearing lug and whose other end expediently has an limit stop, has at least one latching recess on the side opposite the flat side. It is hereby possible to superpose latching members and stepless brake members according to the invention, wherein according to the invention, the holding force can be imparted even outside the latching positions.

The brake member is expediently a sintered part whose sintered material is composed of the materials specified for the flat side of the holding rod. Herein it is selectively possible to provide the same material as for the holding rod, but it is preferable for a material pairing to be selected in which the material of the brake member differs from that of the surface of the holding rod. Alternatively, the brake member may also be formed as a plastic part produced in an injection-moulding process, which is particularly cost-effective since the geometry of the brake member is more difficult to achieve if the latter is formed as a sintered part. Here, a benefit of the brake member being composed of ceramic is that ceramics are generally significantly more compression-resistant than tension-resistant, such that the brake member which is preloaded in the compression direction has a long expected service life. Herein the lateral surface of the brake member produced from ceramic is not elongated but rather has only a short projection over the back of the front side.

Two brake members are expediently preloaded symmetrically in a direction of the holding rod with respect to the opening in the housing, and the holding rod expediently has two flat sides, such that the holding forces according to the invention are generated on both sides of the holding rod.

According to an alternative and preferred embodiment, the brake member is embodied as a sliding member which is immovable in the direction of the holding rod, with the sliding member bearing against the flat side of the holding rod and thereby forming a friction pair. As a result of being arranged in a positionally fixed manner in the housing, the sliding member is insusceptible to tilting, and the design of the door arresting system is correspondingly simplified. To prevent damage to the flat side and/or to the brake lining, the edge of the sliding member is expediently rounded, with the effective surfaces of the sliding member preferably having a roughness R_{z} of between 1 and 2 in the case of rust-resistant steel, such that the resulting coefficients of friction of the sliding member with the flat side of the holding rod yield expedient holding forces. The sliding member is preferably of cylindrical design such that it can be accommodated in the same housing section as a brake member and caulked therein. In this case, the end side of the cylinder is the effective surface of the is brake member. It is self-evidently also possible for a sliding member of said type to be preloaded in the direction of the holding rod, for example by means of a plate spring or a preload cushion composed of plastic material. As a result of the combination of the sliding member and flat side or brake lining, a high holding force is advantageously obtained with low to completely negligible wear.

The friction combination composed of the flat side or brake lining on the one hand and brake member or sliding member on the other hand is preferably loaded by means of a spring member which is preloaded in the direction of the holding rod, with said spring member preferably acting on an element which interacts with that side of the holding rod which faces away from the sliding member. The element is expediently a latching member which interacts with a corresponding guide path composed of the plastic material of the holding rod and, together with said guide path, can also define preferred latching positions. In the latching positions, the spring member is relaxed, and the holding force is therefore also varied, since the preload of the friction partners on the one hand and the coefficients of friction together define the holding force. It is self-evident that the brake member may also be preloaded instead of the latching member, or even both the brake member and the latching member may be preloaded, with the spring forces then being added. By means of the selection of a high coefficient of friction μ, the basic spring load with which the holding rod is preloaded against the brake member can, as an initial preload, be selected to be lower; in this way, greater percentage changes are possible by means of a corresponding profile of the holding rod or latching depressions or latching recesses, such that the profile of the holding force characteristic curve can be varied more easily.

According to a second preferred refinement of the invention, it is provided that the spring force can be adjusted as a function of the position of the holding rod. One particularly simple and efficient option for achieving this consists in the flat side of the holding rod having a continiously increasing slope, as a result of which the spring member which acts on the brake member is correspondingly compressed and generates an increased loading. Herein it is expediently provided that the spring member has a steep spring characteristic, which is avoided in latching systems, such that small changes in the thickness, that is to say in the extent of the spring member in the direction of the loading by the brake member leads to perceptible increased holding forces.

It is alternatively possible to vary the spring characteristic curve by means of external parameters, for example by means of electromagnetic loading or the like. A further option for varying the spring force consists in a displacement of the abutment against which the spring member is supported.

Herein the spring member is particularly advantageously designed so as to have a spring force which varies as a function of the local position of the holding rod in the housing, and thereby permits a variable holding force. Hereby the local position of the holding rod in the housing may be provided for example by means of an incremental measuring system which measures marks on a point, which is preferably not loaded by the brake member, of the holding rod, alternatively, the control of the brake force may also be sensed by means of a marking for example on the narrow side of the holding rod. It is thus possible by means of a sensing finger, which senses the narrow side of the holding rod or which is guided in a groove recess of the holding rod, to twist the spring which acts on the brake member or to adjust the abutment of said spring, resulting in a varying spring force over the extent of the holding rod. Another option is that the finger scanning the contour transversely influences, via a lip, the alignment of the brake member with respect to the movement direction of the holding rod, and thereby reduces the component which acts in the direction of the flat side of the holding rod. It is thus possible, for example, for the brake member to be arranged in the housing so as to be pivotable transversely with respect to the movement direction of the holding rod, and the effective normal component of the spring force is adjusted depending on the inclination with respect to the normal.

The holding force is thereby influenced in a particularly advantageous manner over the movement travel of the holding rod by virtue of a spring unit which acts in the direction of the holding rod being arranged such that the load of the holding rod by said spring unit varies with the movement of the holding rod. This may be achieved in a particularly simple manner in that the spring unit is arranged between the housing and the holding rod and is designed either as a compression or tension spring in order to assist the movement of the holding rod in the opening or closing direction. In this way, for the holding force, a resultant force from the holding force acting in the direction of the holding rod is generated from the friction between the brake member and surface of the holding rod on the one hand and the loading of the spring unit on the other hand, which leads to an increasing holding force over the extent of the holding rod even in the case of a continuously smooth flat side of the holding rod. It has to be understood that said type of attachment of the spring unit is advantageously possible even with a conventional door arrester with a latching characteristic. The spring unit is preferably arranged between the limit stop of the holding rod and the housing, where said spring unit is not visible. It is however also possible for the spring unit to be provided between the pivot point of the holding rod and the housing, in this case the door arrangement part which adjoins the housing, in particular if an encapsulation is to be provided which advantageously hides the spring unit. It is particularly advantageous for the encapsulation itself to be designed as a spring unit, specifically by virtue of the spring unit being embedded into a casing which forms the encapsulation and, in said casing, generating a load which acts in the direction of the holding rod.

A door arrester according to the invention is also characterized in that the preload is generated by an element which is arranged opposite the brake member and which is loaded by a spring member, with the holding force generated by the flat side and brake member exceeding, by at least half, the holding force generated by the element and holding rod. The difference between the holding forces which are generated is preferably even increased by a factor of 2, particularly preferably by a factor of 2.5 to 20. In an arrangement of said type, in which the holding force generated by the element and holding rod is of secondary significance, the element may be designed as a guide member which is moved on a corresponding guide path of the holding rod and correspondingly stresses the spring member. The spring force of the spring member is therefore set directly by the guide path of the holding rod, and the holding force of the door arrester is therefore set directly by means of the friction member/flat side friction pairing, without the restrictions of such a friction pairing applying to the element. The element may correspondingly be designed as a latching member which also defines conventional latching holding positions in a guide path, which is provided with a latching recess, of the holding rod. Surprisingly, a door arrester is thereby created in which the holding force imparted by a spring is introduced predominantly via the holding rod itself in order to generate the holding force. Here, it is also possible to select a spring with a relatively low spring force in order to obtain holding torques, as a result of which the wear to the guide path is reduced and it is made possible to use less expensive plastics.

Further advantages and refinements of the invention can be gathered from the following exemplary embodiments and from the dependent claims.

The invention is explained in more detail below with reference to the appended drawings on the basis of preferred exemplary embodiments.

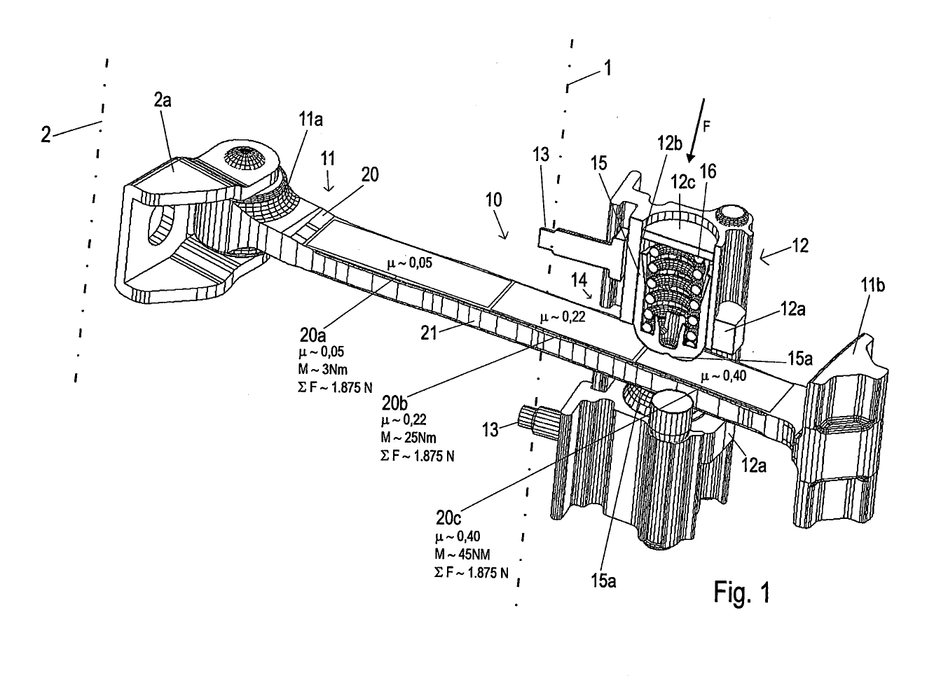

FIG. 1 shows a first preferred exemplary embodiment of a door arrester according to the invention having a plurality of sections of the flat side of the surface.

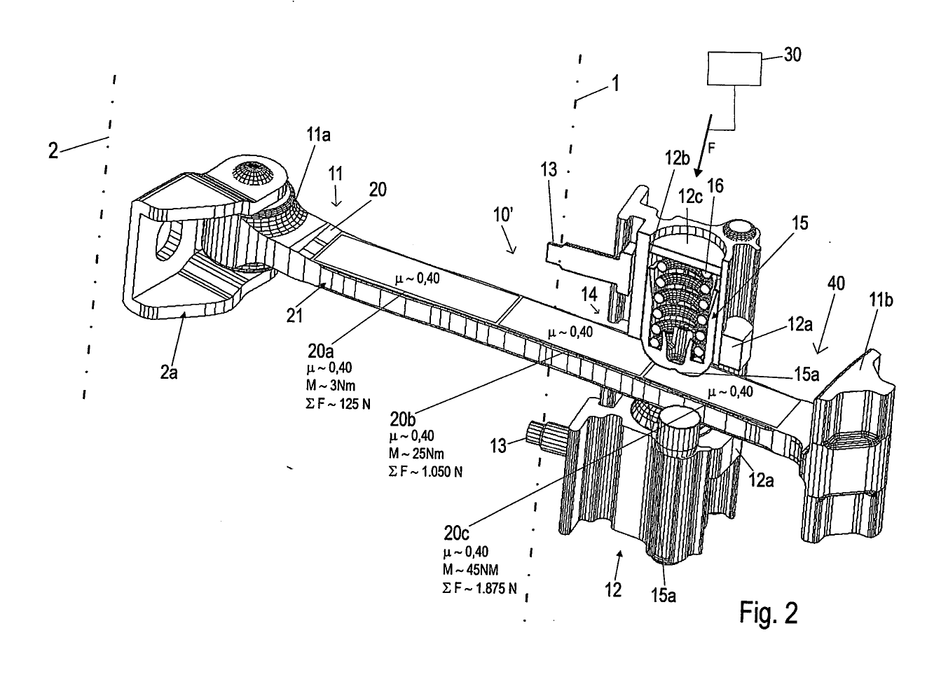

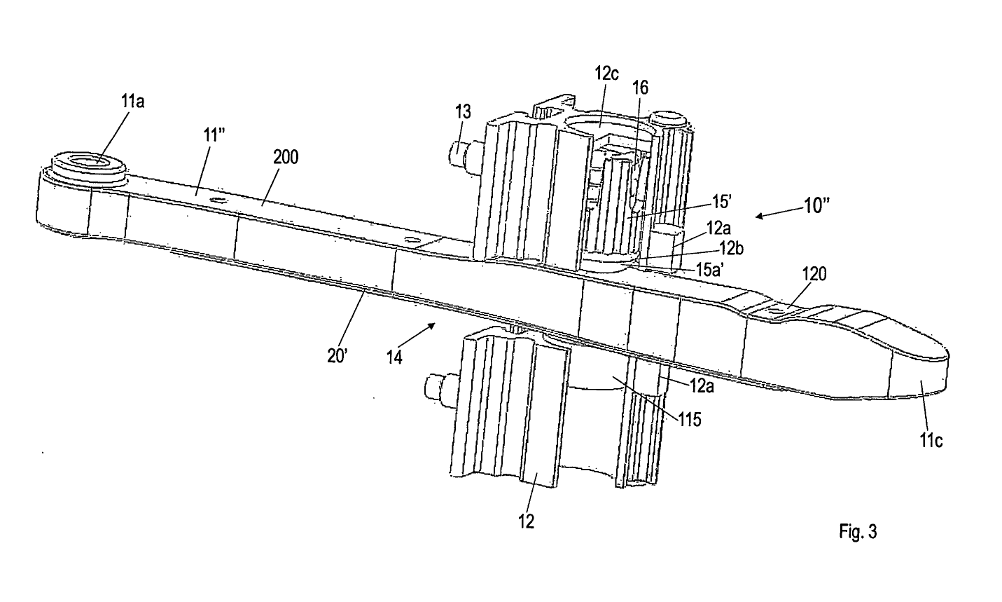

FIG. 2 shows a second preferred exemplary embodiment of a door arrester according to the invention with an adjustable spring characteristic.

FIG. 3 shows a third preferred exemplary embodiment of a door arrester according to the invention.

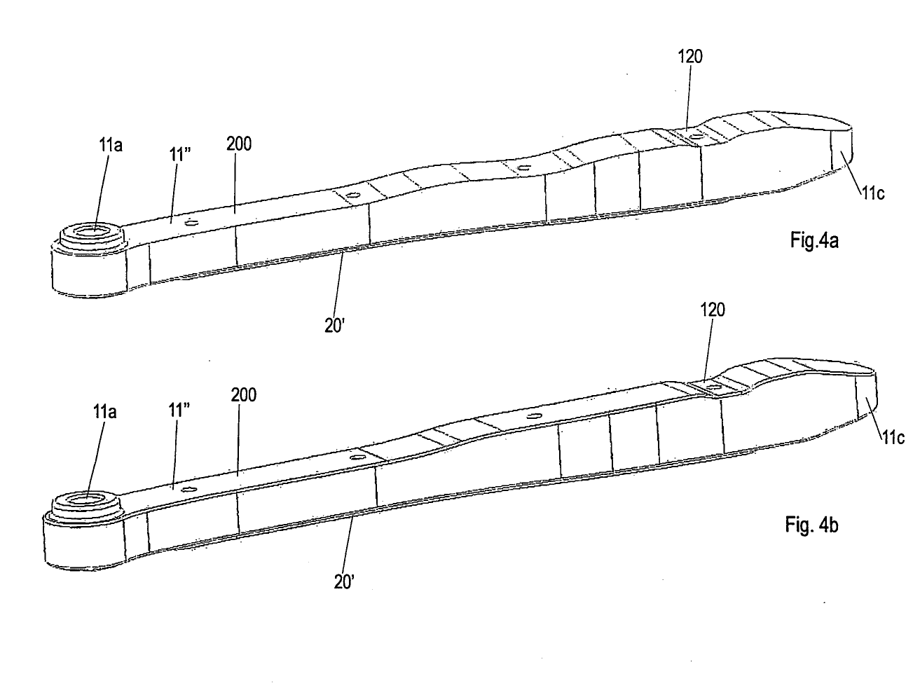

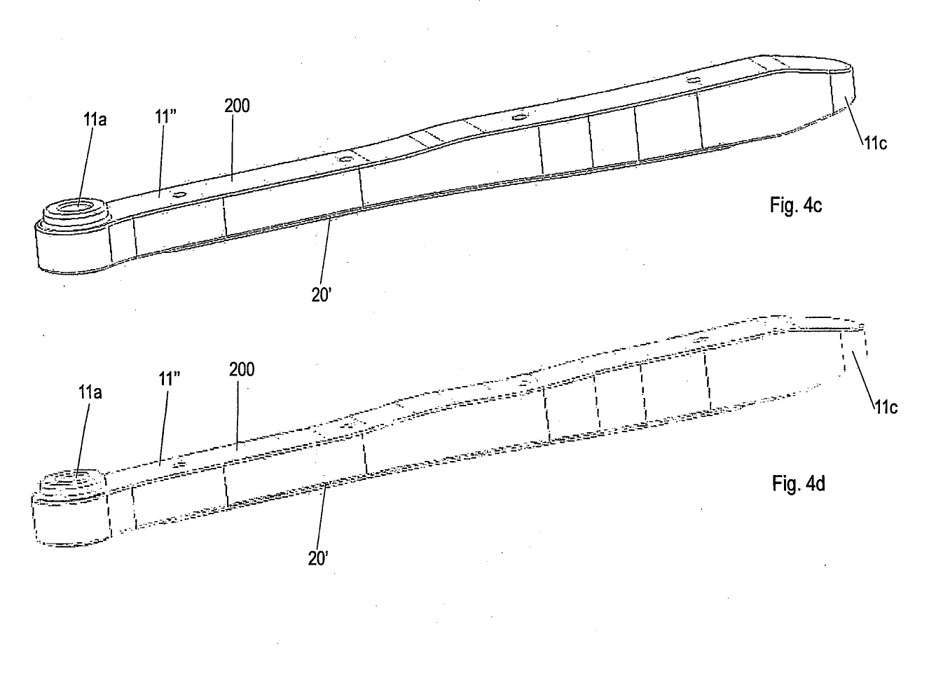

FIG. 4a-d show alternative exemplary embodiments of holding rods for the door arrester from FIG. 3.

FIG. 1 shows a partially sectional illustration of a first exemplary embodiment of a door arrester according to the invention, which is denoted overall by the reference numeral 10. The door arrester 10 comprises a holding rod 11 and a housing 12. The housing 12 is fixed by means of screws 13 to a door frame part 1 indicated by the dash-dotted line 14, while the holding rod 11 is held in a pivotable fashion with a bearing lug 11a in a bearing block 2a which is fastened to the door 2 indicated by dash-dotted lines. At the end opposite the bearing lug 11a, the bearing rod 11 has an end stop 11b which abuts against the stop buffer 12a of the housing 12.

The housing 12 is produced from a profiled section which is composed of aluminum and which has a central opening 14 for the lead through of the holding rod 11. Two brake members 15 are arranged opposite one another transversely with respect to the opening 14 in a central cylindrical chamber 12b of the housing 12, wherein in FIG. 1, the upper one of said brake members 15 is illustrated in a sectional view and only substantially the end side 15a of the lower one of said brake members 15 is visible. Arranged in the chamber 12b is an abutment 12c against which a first end of a spring member 16 is supported, while the second end of the spring member 16 is supported against the rear side, the front side 15a pointing toward the holding rod, of the spring member. As can be seen in FIG. 1, the spring member 16 is embodied as a helical spring. Correspondingly inversed is the arrangement of the lower brake member 15 with the spring member 16 arranged therein.

The holding rod 11 is formed as a sintered part composed of an SiC-based ceramic and has, in each case on the top and bottom, a flat side (denoted by 20) which faces toward the end side 15a of the brake member, and narrow sides 21 between the flat sides 20. The flat side 20 has three sections 20a, 20b and 20c with different surface properties; herein the section 20a defines an idle region shortly before the door is closed; the section 20b defines a preliminary holding region which corresponds to a preliminary latching action; the section 20c corresponds to an end region shortly before the maximum opening angle of the door is reached. The coefficients of friction μ are approximately 0.05 in section 20a, approximately 0.22 in section 20b and approximately 0.40 in section 20c. Since the flat side 20 is otherwise planar, the spring force F is constant and set at approximately 1.875 N. In the present case, both flat sides 20 are formed oppositely with the same surface properties in each case, but it is possible for only one side to be formed in this way.

M denotes the torque which, proceeding from a holding force generated by the friction coefficient μ and the spring force F, is generated together with the available lever arm in order to move the holding rod 11 and therefore the door. Depending on the movement direction, the movement torque M is an opening or closing torque.

In the case described here, the movement torques M generated are approximately 3 Nm for the section 20a, approximately 25 Nm for the section 20b, and approximately 45 Nm for the section 20c. The sections 20a, 20b and 20c are produced with a surface composed of sintered material, predominantly silicone carbide (SiC), with the surfaces of the regions 20b and 20a having lower coefficients of friction μ as a result of finish-machining.

The door arrester 10 thereby permits stepless immobilization, with the holding forces being different in the regions 20a, 20b and 20c and being set by the selected coefficients of friction μ.

In the second exemplary embodiment of a door arrester 10′ according to FIG. 2, the same reference numerals to those in FIG. 1 are used to denote identical or structurally similar parts, such that only the differences are explained here.

In contrast to the exemplary embodiment in FIG. 1, the three sections 20a, 20b and 20c of the holding rod 11 are formed with the same coefficient of friction μ of approximately 0.40. In contrast to the exemplary embodiment in FIG. 1, the holding rod here has a metal core to which a hard material coating composed of an SiC—Si₃N₄ mixture has been applied in powder metallurgical form by sintering in the region of the flat side 20. The brake members 15, too, are produced in powder metallurgical form from 99.9% Si₃N₄. In the door arrester 10′ in FIG. 2, however, the spring force F indicated by an arrow is variable and is approximately 125 N in the region of the section 20a, approximately 1050 N in the region of the section 20b, and approximately 1875 N in the region of the section 20c. This results in movement torques M of approximately 3 Nm in the section 20a, approximately 25 Nm in the section 20b, and approximately 45 Nm in the section 20c. It can be seen that the resulting holding forces and movement torques substantially correspond to those from the exemplary embodiment in FIG. 1. It is therefore possible to set a desired holding force by adjusting different parameters.

In the present exemplary embodiment, the variation of the spring force F takes place by means of a controller 30 which, by adjusting the abutment 12c, stresses to a greater or lesser extent the spring member 16 which is preloaded in the channel 12b, and thereby adjusts the force F. The controller 30 may effect the adjustment of the spring force in some other way, with the opening angle of the door expediently being measured for this purpose in order to assign the correct spring force to the sections 20a, 20b and 20c in each case.

Also schematically illustrated in FIG. 2 is a spring unit 40 which is inserted between the housing 12, in this case that region which faces away from the door frame 1, and the holding rod 11, in this case the limit stop 11b. The spring unit 40 is compressed as the door is opened and is expanded as the door is closed. Depending on whether the spring is designed as a compression or tension spring, it is therefore possible, in the case of the compression spring, to provide assistance during the closing of the door, or in the case of the tension spring, to provide assistance during the opening of the door, with the force which is introduced by the spring unit 40 into the door arrester 10′ being superposed on the holding force and hereby effecting a change in the characteristic curve of the resultant overall holding force. It is also possible for the change in the resultant holding force to be effected only by means of the spring unit 40. As an alternative to the arrangement of the spring unit 40 illustrated in FIG. 2, said spring unit 40 may also be arranged between other parts of the housing 12 and holding rod 11 which are pivotable relative to one another.

FIG. 3 schematically shows a further exemplary embodiment of a door arrester 10″ in which the same reference numerals to those in FIG. 1 or 2 denote the same or structurally similar parts, such that only the differences will be explained here.

As in the exemplary embodiments of FIGS. 1 and 2, the door arrester 10″ in FIG. 3 has a housing 12 through which a holding rod 11″ extends. In the illustrated exemplary embodiment, the holding rod 11″ does not have an limit stop but rather has a tapered end 11c which makes it possible for the holding rod 11″ to be inserted into the end-side opening 14 when the housing 12 is already mounted. This facilitates a later exchange.

In contrast to the preceding exemplary embodiments, the holding rod 11″ is formed as a plastic injection-moulded part composed of polyamide, with a metal core being provided in order to increase the stability of said holding rod 11″. The upper wide side 200 has a smooth surface profile similar to a polished surface, as is known from conventional holding rods for door arresters composed of plastic, and defines an upper guide path 200. In contrast, the lower wide side 20′, which forms a flat side, is formed by a friction lining or brake lining which is embedded into the plastic material and which, in the present case, runs over the entire length of the holding rod 11″ and, over said extent, has a constant high coefficient of friction μ of between 0.14 and 0.2. As a brake lining 20′, it is possible to use a commercially available brake lining, such as is used for example for motor vehicle brakes, which are often composed, as sintered parts, of hard metal, ceramic or a combination of powdered petroleum coke, metal and a resin or rubber binding agent. Here, to prevent the generation of noise, organic substances or plastics are added as additives and filler materials which improve the sliding properties in relation to the generation of noise. In the present case, the friction lining is embedded into the plastic material during the extrusion coating of the holding rod 11″, though it is also possible for the brake lining to be adhesively bonded, riveted, or connected in some other way to the corresponding surface of the holding rod after the production of the holding rod. In particular, it is possible for the brake lining 20′ to be attached by means of clips, such that an exchange is possible, with the wear of a brake lining of said type as a result of the door opening movement generally being negligible.

To obtain a uniform holding torque, the brake lining 20′ is artificially aged before being installed into the door arrester 10″, but expediently even before being attached to the holding rod 11″, in order to prevent a change in the braking torque as a result of a running-in process. This may take place for example by virtue of the brake lining being correspondingly dressed.

In contrast to the preceding exemplary embodiments, the element 15′ which is preloaded by the spring member 16 is not a brake member but rather a latching member. In the present case, the latter is of similar design to the brake members 15 of the two preceding exemplary embodiments; said latching member is however not provided with a friction surface but rather serves to guide the holding rods 11″ and can also easily overcome ramps in the guide path 200, as are required for latching engagement. Correspondingly, a latching mark or latching recess 120 is provided in the guide path 200 close to the maximum door opening angle. It is however also possible for a plurality of latching recesses to be provided.

In the housing 12, only one latching member 15′ is loaded by a spring member 16 against the holding rod 11″. On the side opposite the latching member 15′, a brake member 115 which is embodied as a sliding member is caulked in the corresponding chamber 12b of the housing 12. The sliding member 115 is composed of stainless steel, such as for example Nirosta, and has a roughness R_{z} of between 1 and 2. Said roughness may be provided, for example, by means of grinding with corresponding graining or sand blasting. The sliding member 115 is formed as a cylindrical body which is fixed in the chamber 12b so as to be immovable, with the end surface which points toward the holding rod 11″ being substantially in contact with the friction lining 20′. Here, the lower side of the holding rod 11″ with the friction lining 20′ is of substantially flat design, such that the end side of the sliding member 115 and the friction lining 20′ bear against one another in each case over their full area. It is however possible to provide gradients in the side of the holding rod 11″ and in the brake lining 20′, wherein the radius should be substantially adapted to the surface of the sliding member 115, and wherein no depressions are provided in order to maintain the braking torque.

The upper side 20 of the holding rod 11″ runs in a completely flat fashion in the closed region of the door situated close to the bearing lug 11 a, such that the spring member 16 is either relaxed or stressed only to a small extent. In the further profile, said guide path 200 which faces toward the latching member 15′ rises, and close to the maximum opening position of the door, provides a latching recess 120 in which the spring 16 of the latching member 15′ relaxes to a small extent.

It can be stated that the coefficient of friction of the guide path 200 of the holding rod 11″ is significantly lower than that of the brake lining 20′, at least by one third, but generally even by a factor of 1 to 2, or in specially mounted cases even by a factor of 10 if, for example, the guide path 200 has been lubricated. The roughness of the end side 15a′ of the latching member 15 is also correspondingly lower than that of the sliding member 115, such that the sliding pairing of the upper side of the holding rod generates a negligible, or at least less significant braking torque, in relation to the sliding pair of the underside of the holding rod. Nevertheless, the spring force of the spring 16, which also acts via the body of the holding rod 11″ on the brake lining 20′/sliding member 115 pairing, serves to influence the effective braking torque of the door arrester 10″, that is to say the spring force is set by means of the profile of the upper side of the holding rod 11″, while the braking torque is generated by the lower side of the holding rod 11″. Therefore, in the region of the latching depression or latching recess 120, the holding torque is lower on account of the reduced spring force.

In the present exemplary embodiment, the coefficient of friction μ of the brake lining 20′ is between 0.14 and 0.2, with it being possible to use linings whose coefficient of friction μ lies between 0.12 and 0.3 or above; the roughness R_{z} of the brake lining lies between 12 and 30. Since the brake lining is subjected to dry friction, these are also the effective values to be taken into consideration for the holding torque. In the present exemplary embodiment, the coefficient of friction μ′ of the dry guide path 200 composed of polyamide is only between 0.08 and 0.14, and the roughness R_{z}′ of the guide path 200 is between 0.5 and 5. However, the holding torque is further reduced by virtue of lubrication with oil or grease being provided in the region of the guide path 200. Even in the dry state, however, there is a difference in the value ranges of the coefficients of friction by approximately a factor of 2 or more.

FIGS. 4a to 4d show further exemplary embodiments of holding rods 11″. All of said exemplary embodiments have a brake lining 20′ on the underside, while the upper side 200 of the holding rod 11″ is formed substantially as a guide path. It can be seen that, in the exemplary embodiments shown, even the underside of the holding rod 11″, which underside supports the friction lining 20″, is provided with a not strictly linear slope, wherein the effective holding torque is defined ultimately by the variations in thickness of the holding rod 11″ together with the selection of the spring member 16. The provision of a brake lining and of a sliding member which, together, induce a high braking torque, makes it possible to install a spring member with a low spring constant. Furthermore, it is possible by means of the geometric configuration of the holding rods to provide very much more variable curve profiles of the holding torque over the door opening angle than is possible with conventional door arresters, since the profile of the guide path 200 influences the preload of the spring member 16 and therefore the normal force which acts between the brake lining 20″ and sliding member 115. The profile of the guide path 200 therefore serves to set the local loading along the extent of the holding rod 11″. Furthermore, it is possible without a significant drop in the holding torque to set local minima in the holding force corresponding to a holding position at a preferred door opening angle. Finally, it is made possible by means of the provided arrangement to adapt holding rods to individual customer requirements by means of a corresponding selection of the coefficients of friction of the brake lining and adaptation of the profile for the brake member, such that the customer can select his preferred choice from a multiplicity of possible braking torque profiles and preferred opening angles, and only the holding rod needs to be exchanged here.

The invention has been explained above on the basis of a plurality of preferred exemplary embodiments. It is self-evident that the features presented in the two exemplary embodiments may also be combined in order to generate resultant holding forces. It is thus possible with a less variable spring force and less significantly deviating coefficients of friction to still obtain an expedient characteristic of the holding sections for a door arrester.

The invention has been explained above on the basis of exemplary embodiments in which the edges of the brake lining or the surfaces of the holding rod run with an increased coefficient of friction substantially parallel to the lateral boundary of the holding rod. It is however also possible for the width of the brake lining to be varied over the profile of the holding rod and to thereby locally vary the resulting holding torque in a planned fashion. It is also possible for the brake lining to be formed with a texture which increases or reduces the coefficient of friction according to the alignment of said texture as a function of the movement direction of said holding rod. It is hereby possible to form the braking torque to be greater in the opening direction than in the closing direction.

The invention has been explained above on the basis of exemplary embodiments in which the holding rod has a substantially rectangular cross section and in which a pairing of a brake member and a flat side is arranged normally with respect to the direction of action of the spring member. It should be understood that it is sufficient if the direction of action of the spring has a component which acts on the flat side. It is thus also possible, for example, for the holding rod to have a triangular profile in cross section, for example the profile of an equilateral triangle, which stands on one tip, with that side of the holding rod which is formed by the upper edge of the triangle being acted on by a guide member while the other two edges interact with brake members which are expediently arranged on a housing but which may also be provided directly on the vehicle part through which the holding rod extends. If a trapezoidal cross section is used, it is likewise possible, instead of the loading in the direction of the oblique edges of the trapezoid, for the loading to take place away from these by means of correspondingly preloaded brake members which act normally with respect to the parallel edges of the trapezoid, thereby ensuring simple installation. This also has the result that the flat side need not mandatorily form a straight line in cross section, but rather may also be formed from a plurality of planes, for example in the form of a V, a W or other profiles, wherein the flat side may also be discontinuous within said profile.

All of the door arresters according to the invention presented in the exemplary embodiments are motor vehicle door arresters designed for a side door of a motor vehicle, and are therefore industrially applicable as door arresters for a motor vehicle.

1 to 63. (canceled)

64. A door arrester, comprising
a holding rod which can be fastened to one of a door and a door frame,
at least one brake member which interacts with a flat side of the holding rod,
wherein the flat side and the brake member are preloaded against one another at least in regions of the extent of the holding rod,
wherein a holding force acting at least in one of the movement directions of the holding rod can be generated depending upon the local surface properties of the flat side and of the brake member,
wherein the preload is generated by an element which is arranged opposite the brake member and which is loaded by a spring member, and
wherein the holding force generated by the flat side and the brake member exceeds, by at least half, the holding force generated by the element and the holding rod.

65. The door arrester as claimed in claim 64, wherein the holding rod can be pivotably fastened to the one of the door and the door frame, wherein a housing can be fastened to the other of said door and said door frame, and wherein the holding rod extends through an opening in the housing.

66. The door arrester as claimed in claim 64, wherein the flat side facing toward the brake member is substantially planar.

67. The door arrester as claimed in claim 64, wherein the flat side comprises at least one friction or brake lining such as a sintered material.

68. The door arrester as claimed in claim 64, wherein the flat side has a plurality of sections with different coefficients of friction.

69. The door arrester as claimed in claim 64, wherein the holding rod is produced as a plastic part, and wherein the holding rod comprises a core of metal.

70. The door arrester as claimed in claim 64, wherein the brake member is embodied as a sliding member having a flattened front side, wherein the front side faces toward the flat side of the holding rod and rests against the flat side and wherein the sliding member is immovable toward the holding rod.

71. The door arrester as claimed in claim 65, wherein the brake member is embodied as a sliding member having a flattened front side which engages the flat side of the holding rod, and wherein the sliding member is caulked in the housing.

72. The door arrester as claimed in claim 64, wherein the element is designed as a latching member, and wherein a guide path which is loaded by said latching member is provided on the opposite side of the flat side of the holding rod.

73. The door arrester as claimed in claim 72, wherein the guide path has at least one latching depression which, together with the latching member, permits a latching characteristic.

74. The door arrester as claimed in claim 72, wherein flat side has, at least partially along its extension, a friction coefficient being larger than a friction coefficient of the guide path, and wherein the flat side is embodied as a brake lining different from an encapsulation of the holding rod.

75. The door arrester as claimed in claim 72, wherein the latching member is made of plastic and is preloaded in a direction of the holding rod by a spring member received in a recess of the latching member.

76. The door arrester as claimed in claim 64, wherein the brake member is preloaded by means of a second spring member, and wherein the brake member is displacable toward the flat side of the holding rod.

77. The door arrester as claimed in claim 76, wherein the spring member is received at least partially within the lateral surface of the brake member.

78. The door arrester as claimed in claim 64, wherein a spring unit is arranged between the holding rod and the housing to unload or load the holding rod in a movement direction.

79. The door arrester as claimed in claim 64, wherein the brake member has a front side, wherein the front side is arranged substantially normal to an effective preload component of the spring member, wherein the flat side of the holding rod comprises a brake lining, and wherein said front side and said brake lining define a friction couple.

80. A door arrester, comprising
a holding rod which can be fastened to one of a door and a door frame,
at least one brake member which interacts with a flat side of the holding rod,
at least one element having a substantially flat front end which interacts with a guide path of the holding rod, the at least one element being arranged substantially opposite the at least one brake member,
wherein a spring member preloads the at least one element against the guide path and urges the flat side toward the brake member at least in regions of the extent of the holding rod, and
wherein the flat side has a larger coefficient of friction than the guide path.

81. A motor vehicle door arrester, comprising
a holding rod which can be fastened to one of a door and a door frame, said holding rod comprising a core of metal covered by a plastic covering,
at least one brake member which interacts with a flat side of the holding rod,
wherein the flat side and the brake member are preloaded against one another at least in regions of the extent of the holding rod,
wherein a holding force acting at least in one of the movement directions of the holding rod is generated as said flat side displaces along said brake member,
wherein the holding rod comprises a brake lining different from said plastic covering, and wherein the brake lining is at least a portion of said flat side.

82. A door arrester, comprising
a housing which can be fastened to one of a door and a door frame,
a holding rod which extends through an opening in the housing and which can be pivotably fastened to the other of the door and the door frame,
at least one brake member which interacts with a flat side of the holding rod and which is arranged in the housing,
wherein the flat side and the brake member are preloaded against one another at least in regions of the extent of the holding rod by a load,
wherein a holding force acting at least in one of the movement directions of the holding rod is generated responsive to frictional engagement conditions of the flat side and the brake member,
wherein at least one of said load and said frictional engagement conditions varies along the extent of the holding rod such that the resultant holding force fluctuates over the extent of the holding rod.

83. A door arrester, comprising
a housing which can be fastened to one of a door and a door frame,
a holding rod which extends through an opening in the housing and which can be pivotably fastened to the other of the door and the door frame, and
at least one brake member which interacts with a flat side of the holding rod and which is arranged in the housing,
wherein the flat side and the brake member are preloaded against one another at least in regions of the extent of the holding rod,
wherein a holding force acting at least in one of the movement directions of the holding rod can be generated depending upon the local surface properties of the flat side and of the brake member, and
wherein a spring unit is connected to the holding rod and to the housing to unload or load the holding rod in a movement direction.
